(19) United States
(12) Patent Application Publication
(10) Pub. No.: US 2022/0078537 A1
(43) Pub. Date: Mar. 10, 2022

(54) PERFORMANCE NECKBAND FOR WIRELESS EARBUDS

(71) Applicant: Plantronics, Inc., Santa Cruz, CA (US)

(72) Inventors: Jacob T. Meyberg Guzman, Santa Cruz, CA (US); Terry M. Carr, Santa Cruz, CA (US); Dave Hansung Kim, Santa Cruz, CA (US); John A. Kelley, Santa Cruz, CA (US)

(73) Assignee: Plantronics, Inc., Santa Cruz, CA (US)

(21) Appl. No.: 17/466,996

(22) Filed: Sep. 3, 2021

Related U.S. Application Data
(60) Provisional application No. 63/075,050, filed on Sep. 4, 2020.

(51) Int. Cl. H04R 1/10

(52) U.S. Cl. CPC H04R 1/105; H04R 2420/07; H04R 1/1016; H04R 1/1025

(57) ABSTRACT

A wearable media device comprising a substantially U-shaped body configured to be worn around a neck of a user. The U-shaped body includes a left section, right section and middle section. The left section is configured to be disposed on the left side of the neck of the user and includes a first docking port configured to receive a first wireless earbud. The right section is configured to be disposed on the right side of the neck of the user and includes a second docking port configured to receive a second wireless earbud. The middle section couples the left and right sections and is configured to be disposed on the back of the neck of the user.

### CROSS REFERENCE TO RELATED APPLICATIONS

This application is a nonprovisional application of and thereby claims benefit under 35 U.S.C. § 119(e) to U.S. Provisional Application Ser. No. 63/075,050 filed on Sep. 4, 2020. U.S. Provisional Application Ser. No. 63/075,050 is incorporated herein by reference in its entirety.

### BACKGROUND

Wireless earbuds are commonly used with various types of computing devices in order to receive and transmit audio. Due, in part, to the wireless earbuds having a small form factor and lack of entangling wires, the wireless earbuds are popular. However, the small form factor and lack of wires may make the wireless earbuds easily lost and have limited battery life.

### SUMMARY

In general, in one aspect, one or more embodiments relate to a wearable media device that includes a substantially U-shaped body configured to be worn around a neck of a user. The U-shaped body includes a left section, middle section, and right section. The left section is configured to be disposed on the left side of the neck of the user, wherein the left section includes a first docking port configured to receive a first wireless earbud. The right section is configured to be disposed on the right side of the neck of the user, wherein the right section includes a second docking port configured to receive a second wireless earbud. The middle section couples the left and right sections and is configured to be disposed on the back of the neck of the user.

In general, in one aspect, one or more embodiments relate to a wearable media device including first and second wireless earbuds and a substantially U-shaped body. The substantially U-shaped body configured to be worn around a neck of a user and includes a left section, right section and middle section. The left section is configured to be disposed on the left side of the neck of the user, wherein the left section includes a first docking port configured to receive the first wireless earbud. The right section is configured to be disposed on the right side of the neck of the user, wherein the right section includes a second docking port configured to receive the second wireless earbud. The middle section couples the left and right sections and is configured to be disposed on the back of the neck of the user

Other aspects of the disclosure will be apparent from the following description and the appended claims.

### BRIEF DESCRIPTION OF DRAWINGS

FIG. 1 shows a neckband worn by a user in accordance with one or more embodiments of the disclosure.

FIGS. 2A, 2B, and 2C shows a neckband and two associated earbuds in accordance with one or more embodiments of the disclosure.

FIGS. 3A, 3B, 3C, 3D, and 3E shows various configurations of the end of a neckband adapted to receive different types of earbuds in accordance with one or more embodiments of the disclosure.

FIGS. 4A, 4B, and 4C shows various configurations for joining an earbud to an end of a neckband in accordance with one or more embodiments of the disclosure.

FIG. 5 shows an umbilical cord for joining an earbud to an end of a neckband in accordance with one or more embodiments of the disclosure.

FIG. 6 shows a detailed view of an end of a neckband in accordance with one or more embodiments of the disclosure.

FIGS. 7A, 7B, and 7C shows the user interface of a neckband in accordance with one or more embodiments of the disclosure.

FIG. 8 shows a closure mechanism of a neckband in accordance with one or more embodiments of the disclosure.

FIG. 9 shows the user interface of a neckband in accordance with one or more embodiments of the disclosure.

FIG. 10 shows a conformable neckband in accordance with one or more embodiments of the disclosure.

FIG. 11 shows the lower surface of the conformable neckband in FIG. 10 in accordance with one or more embodiments of the disclosure

Like elements in the various figures are denoted by like reference numerals for consistency.

### DETAILED DESCRIPTION

This disclosure describes a wearable media device that a user wears around his or her neck. The wearable media device has a substantially U-shaped body that includes a left section, a right section, and a middle section that joins the left and right sections. The wearable media device includes docking ports so that a pair of wireless earbuds can be removably connected to the left and right sections. The earbuds are held securely in place to allow the user to exercise, to play sports, or to engage in other physical activity without losing the earbuds. Advantageously, the wearable media device may include a battery and charging electronics to allow the wireless earbuds to be charged when inserted into the left and right sections. Additionally circuitry in the wearable media device provides an enhanced user interface (UI) that enables the user to control the earbuds.

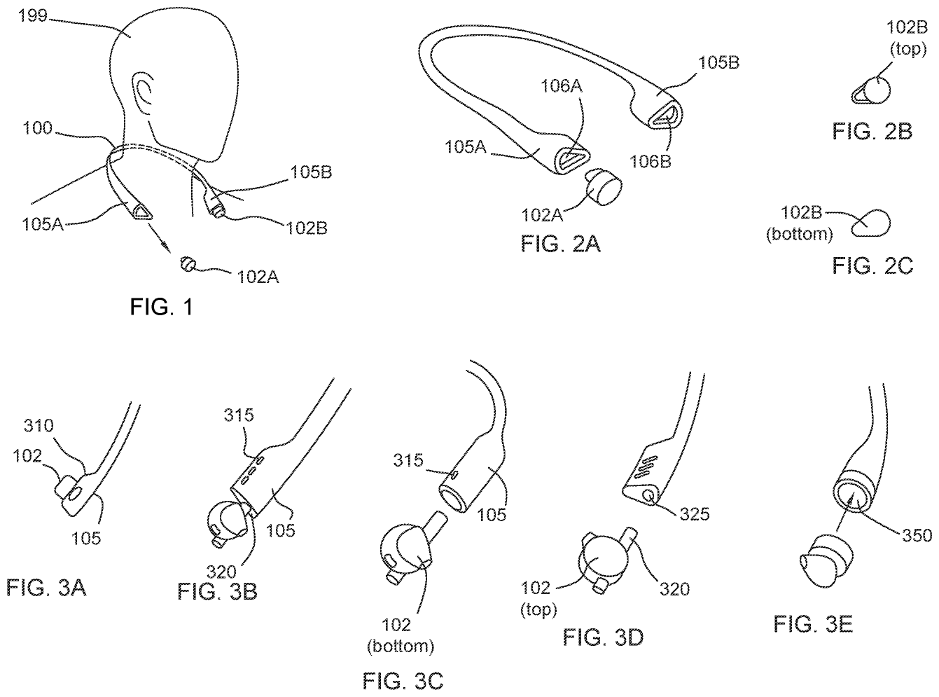

FIG. 1 shows neckband 100 worn around the neck of user 199 in accordance with one or more embodiments of the disclosure. Neckband 100 include a U-shaped body that has a terminal (or end) section 105 at each end of the U-shaped body. A right end section 105A rests on the right shoulder proximate the base of the neck. A left end section 105B rests on the left shoulder proximate the base of the neck. A first earbud 102A is shown removed from a docking port at the end of right section 105A. A second earbud 102B is shown removably inserted in another docking port at the end of left section 105B. Specifically, the neckband includes terminal sides that are substantially perpendicular to the longitudinal side (i.e., side that curves around the neck) of the neckband. In the embodiment shown in FIGS. 1-3, the wireless earbuds removably connect to the terminal sides. “Removably” refers to the ability of a user to connect and disconnect without external tools (i.e., tools not in the neckband or earbuds). Namely, the user may connect or disconnect the earbuds while wearing the neckband with just the users' fingers.

For the sake of brevity, right end section 105A and left end section 105B may simply be referred to as right section 105A and left section 105B, respectively. Earbuds 102A and 102B are configured to communicate bidirectionally with each other, with neckband 100, and with a computing device, such as a mobile phone, desktop or laptop computer, desktop phone, wearable device, a stereo system, a vehicle infotainment system, and the like.

FIGS. 2A, 2B, and 2C shows neckband 100 and two associated earbuds 102A and 102B in greater detail in accordance with one or more embodiments of the disclosure. Right section 105A comprises docking port 106A, which is located at the terminal side of right section 105A. Earbud 102A is shown withdrawn, or disconnected, from docking port 106A. Left section 105B comprises docking port 106B, which is located at the terminal side of left section 105B. Earbud 102B is shown withdrawn, or disconnected, from docking port 106B.

Earbuds 102A and 102B generally comprise a main body that is visible when earbud 102 is inserted into the ear. Earbuds 102A and 102B also generally comprise a foam or soft rubber cone-shaped body that inserts deeper into the ear canal and directs sound from the internal speaker towards the eardrum. An earbud may direct sound from a shallower body without inserting into the ear canal. FIGS. 2B and 2C show a top view of the main body of earbud 102B and a bottom view of the cone-shaped body of earbud 102B. In a typical embodiment, when an earbud 102 is connected to a docking port 106, the cone-shaped body is inserted into the docking port 106 and the main body of the earbud 102 remains outside. In FIGS. 2A, 2B, and 2C, docking ports 106A and 106B have approximately teardrop-shaped openings to accommodate earbuds 102A and 102B.

FIGS. 3A-3E shows various configurations of the end portions of right section 105A and left section 105B of neckband 100, wherein the end portions may be adapted to receive different types of earbuds 102 in accordance with one or more embodiments of the disclosure. In FIG. 3A, earbud 102 is inserted into a slot 310 on one side of the end section 105. In FIG. 3B, an earbud 102 is inserted by means of plug 320 into end section 105. FIG. 3B also shows microphone 315 on the side of section 105. FIG. 3C shows earbud 102 withdrawn from section 105, which has a circular cross-section. FIG. 3D shows earbud 102 withdrawn from section 105, which has a cylindrical docking port 325 into which plug 320 is inserted when earbud 102 is removably connected to end section 105. In FIG. 3E, earbud 102 may have a metallic body that is removably connected to end section 105 by means of a magnet 350 on the end of section 105.

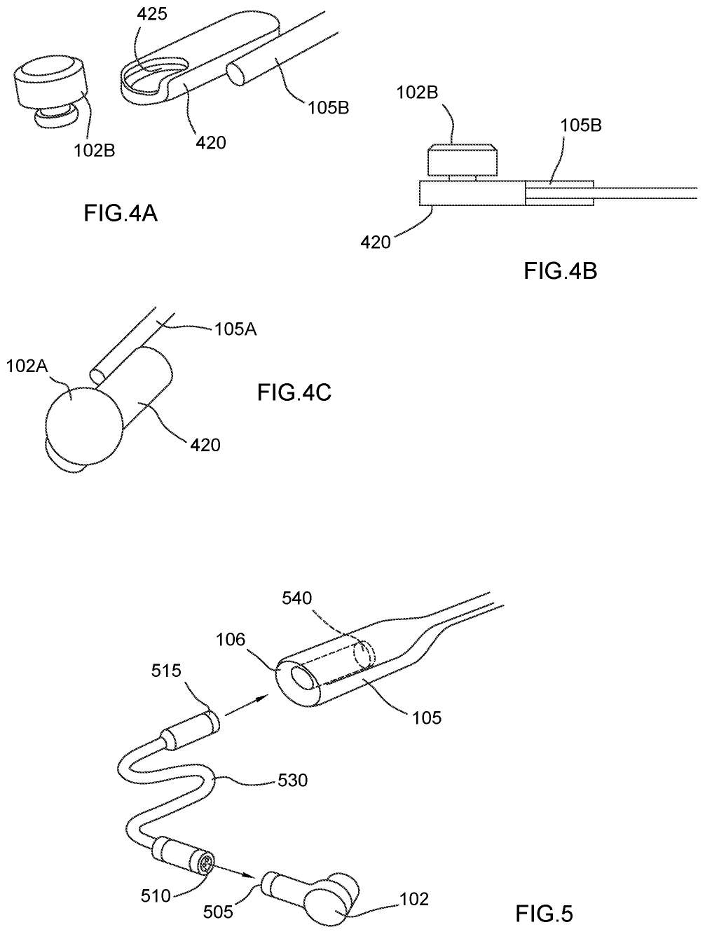

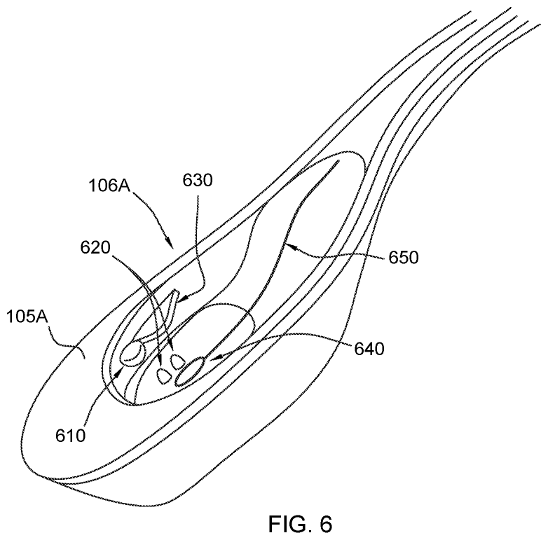

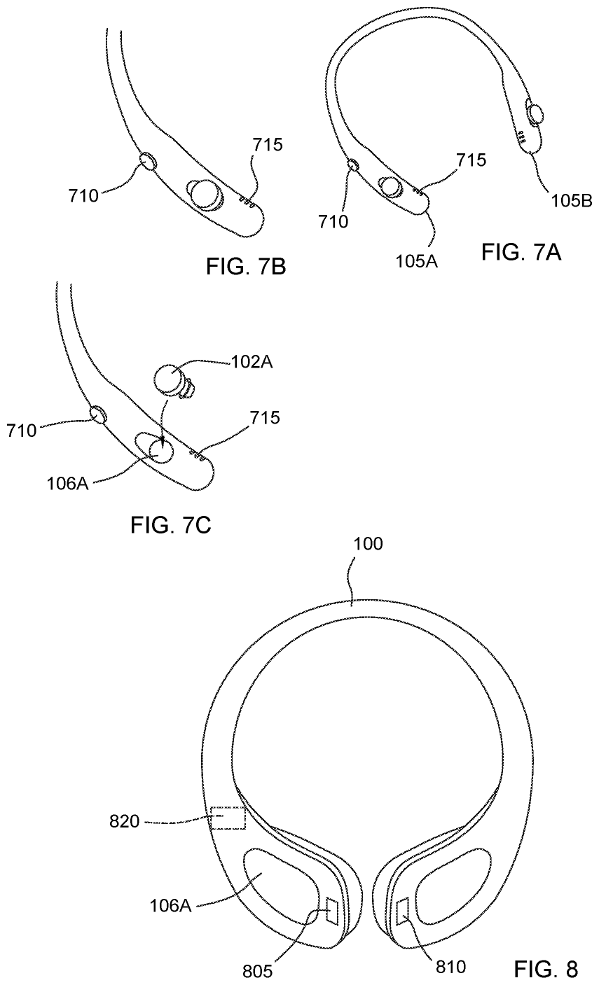

FIGS. 4A-4C shows various configurations for joining earbud 102 to an end of neckband 100 in accordance with one or more embodiments of the disclosure. FIG. 4A is a perspective view of left section 105B, which includes a docking port 420 mounted on the side of left section 105B near the terminus of the left section. The docking port 420 includes slot 425 configured to receive earbud 102B and removably lock 102B into place. FIG. 4B is a side view of left section 105B illustrating earbud 102B fully inserted into slot 425 in docking port 420. FIG. 4C is a top view of right section 105A illustrating earbud 102A fully inserted into slot 425 in docking port 420. The docking port 420 may be mounted on either the inside (closer to neck) or the outside (further from neck) of right section 105A and left section 105B. The docking port 420 for earbuds 102 may be mounted on the top of the neckband with docking slot 425 as shown in FIG. 6 and FIG. 7.

FIG. 5 shows umbilical cord 530, which is configured to join an earbud 102 to an end of neckband 100 in accordance with one or more embodiments of the disclosure. Earbud 102 comprises a magnet 505. End section 105 comprises a terminal docking port 106 and an internal magnet 540. Umbilical cord 530 comprises magnet 510 and magnet 515, which are connected to opposite ends of umbilical cord 530. Magnet 510 attracts and removably connects to magnet 505 on earbud 102. Magnet 515 may be inserted into docking port 106 and attracts and removably connects to magnet 540. In some embodiment, the cord 530 may provide power from a battery to charge the earbuds 102 while using the neckband 100. The earbuds 102 could then be separated from the cord 530 when used for wireless listening only or listening and speaking (receive and transmit).

FIG. 6 shows a detailed view of right end section 105A of neckband 100 in accordance with one or more embodiments of the disclosure. End section 105A comprises a guide ramp 640 for guiding earbud 102A into position in docking port 106A. The interior of docking port 106A comprises detent position stop 610, electrical charging contacts 620, docking flange 630, and magnet 640. Detent position stop 610, docking flange 630, and magnet 640 are configured to engage with similar structures on the bottom of earbud 102A, so that earbud 102A may “snap” into place and be securely held in docking port 106A. In this manner, earbud 102A does not easily fall out of docking port 106A. In some embodiments, the user may twist or rotate earbud 102A in order to lock earbud 102A in place. In some embodiments, the charging contacts 620 may be wireless charging transmitters that communicate with wireless charging receivers on earbuds 102A. This may allow for a clean surface on the earbud 102 and the dock. The detent position stop 610 and docking flange 630 may be combined to a single feature.

Electrical charging contacts 620 make an electrical connection to similar contacts on earbud 102A. Wireless charging between the earbuds 102 and the neckband 100 may also be implemented for power delivery and data. According to an embodiment of the present disclosure, neckband 100 comprises a battery (not shown) and an electronic control module (not show) configured to charge earbuds 102 when earbuds 102 are inserted into docking ports 106. The electronic control module also may include wireless transceivers and a digital signal processor (DSP) that enable the control module to communicate with wireless earbuds 102 in order to transmit audio from microphones 315 in neckband 100 to earbuds 102 and to control a user interface (UI) (not shown) that adjusts the volume of the speakers in earbuds 102. By combining the input from the microphones in the neckband 100 and the earbuds 102, the performance can be enhanced by further spacing between the microphones and detecting speech from background noise.

FIGS. 7A, 7B, and 7C shows the user interface (UI) of neckband 100 in accordance with one or more embodiments of the disclosure. The user interface may comprise microphone 715 and one or more control buttons 710, which are in communication with the DSP in neckband 100. In FIGS. 7A, 7B, and 7C, docking ports 106 for receiving earbuds 102 are disposed on upper surfaces of right section 105A and left section 105B. Control button(s) 710 may be, for example, a mute button or a call button to answer and to end a phone call on the user's mobile phone as well as media controls. The control button 710 may be a toggle switch that can be used to increase or decrease volume in earbuds 102. The one or more control buttons 710 may be any of various different types of switches, including touch switches and mechanical switches.

FIG. 8 shows a closure mechanism of neckband 100 in accordance with one or more embodiments of the disclosure. Battery 820 is disposed in neckband 100, which comprises a flexible material that may be shaped to conform to the neck and shoulders of the user. The neckband may include a magnet 805 on right section 105A and a magnet 810 on left section 105B that form a closure mechanism. When the user wears neckband 100 and brings the ends of right section 105A and left section 105B together in close proximity, magnets 805 and 810 may connect together to keep neckband 100 in a closed loop configuration around the neck of the user. The closed loop configuration keeps the neckband 100 in place around the neck when the user is engaged in physical activity, such as exercise.

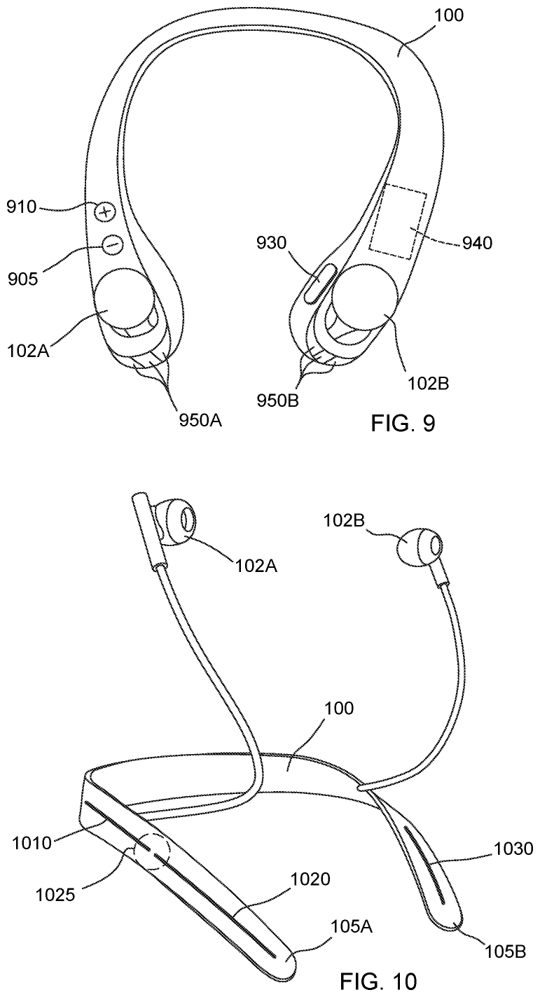

FIG. 9 shows the user interface (UI) of neckband 100 in accordance with one or more embodiments of the disclosure. Neckband 100 comprises control module 940 that includes a digital signal processor (DSP). The DSP processes instructions for the control module 940 to communicate with wireless earbuds 102. The UI may include an increase volume button 910, decrease volume button 905, light emitting diode (LED) clusters 950A and 950B, and a control button 930, which may be a mute button or a call button to answer and to end a phone call on the connected computing device. Each of LED clusters 950A and 950B comprise a plurality of different colored LEDs. The On/Off state and colors of the LEDs may be used to indicate a variety of status information, including low charge of the internal battery 820, incoming call, call state, active call, mute on, or that the earbuds 102 are linked to the wireless transceiver in control module 940. The user interface (UI) may further include a haptic device that is incorporated into or coupled to control module 940. The haptic device may vibrate to indicate to the user certain status information, such as an incoming call. Haptic devices (vibration motors or linear actuators) are less desirable in an earbud. However, on a neckband or a body-worn device, it is an improved method for notifications.

FIG. 10 shows conformable neckband 100 made from a semi-rigid conformable material in accordance with one or more embodiments of the disclosure. Neckband 100 includes wired earbuds 102A and 102B in the exemplary embodiment. However, this is by way of illustration only. In other embodiments, conformable neckband 100 may comprise docking ports 106 and wireless earbuds 102 as above in FIGS. 1-9. Conformable neckband is reinforced by internal semi-rigid wires 1010, 1020, and 1030 that enable neckband 100 to hold the shape into which the user bends neckband 100. For example, once the user puts neckband 100 around his or her neck, the user may bend right section 105A and left section 105B downward over the user's front collarbones and onto the top of the user's chest. The gap 1025 between wires 1010 and 1020 limits the degree to which the neckband 100 may be bent.

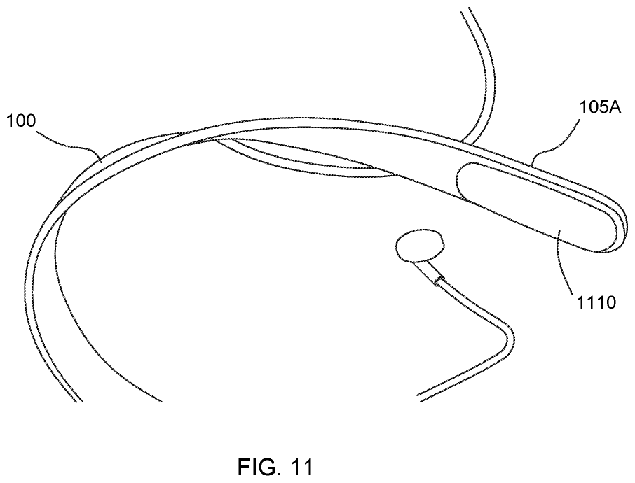

FIG. 11 shows the lower surface of the conformable neckband 100 in FIG. 10 in accordance with one or more embodiments of the disclosure. In FIG. 11, a plurality of frictions pads, such as exemplary friction pad 1110, may be adhered to the lower surfaces of the right section 105A and the left section 105B to prevent neckband 100 from sliding on the shirt or skin of the user, thereby keeping the neckband 100 in place when the user is exercising.

A modified version of the disclosed neckband 100 may be adapted in other embodiments to be worn as a wristband or armband. In such alternate embodiments, the wearable band 100 would encircle the wrist, forearm, or bicep of the user and the right and left sections 105 would become end sections that may be coupled together by hook and mesh closures, buttons, snaps, or the like.

In the detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, although the description includes a discussion of various embodiments of the disclosure, the various disclosed embodiments may be combined in virtually any manner. All combinations are contemplated herein.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A wearable media device comprising:
a substantially U-shaped body configured to be worn around a neck of a user, the U-shaped body comprising:
a left section configured to be disposed on the left side of the neck of the user, wherein the left section includes a first docking port configured to receive a first wireless earbud;
a right section configured to be disposed on the right side of the neck of the user, wherein the right section includes a second docking port configured to receive a second wireless earbud; and
a middle section coupling the left and right sections and configured to be disposed on the back of the neck of the user.

2. The wearable media device of claim 1, wherein the first docking port is disposed at an end of the left section and the second docking port is disposed at an end of the right section.

3. The wearable media device of claim 1, wherein the first docking port is disposed on an upper surface of the left section and the second docking port is disposed on an upper surface of the right section.

4. The wearable media device of claim 1, wherein the first and second wireless earbuds are detachable from the first and second docking ports, respectively.

5. The wearable media device of claim 4, wherein the first docking port comprises a socket configured to securely lock the first wireless earbud in place when the first wireless earbud is inserted into the socket.

6. The wearable media device of claim 5, wherein the first docking port comprises an electrical contact configured to charge the first wireless earbud when the first wireless earbud is inserted into the socket.

7. The wearable media device of claim 1, wherein the U-shaped body comprises a battery coupled to the first and second docking ports and configured to charge the first and second wireless earbuds.

8. The wearable media device of claim 1, wherein the U-shaped body comprises a user interface, the user interface including at least one of a control button, a haptic vibration device, a light emitting diode (LED), and a microphone.

9. The wearable media device of claim 1, wherein the U-shaped body comprises a semi-rigid, conformable material that enables the U-shaped body to be adapted to the size of the neck of the user and to the shape of the shoulders of the user.

10. The wearable media device of claim 9, wherein the U-shaped body comprises a closure mechanism configured to detachably connect an end of the left section and an end of the right section.

11. A wearable media device comprising:
a first wireless earbud;
a second wireless earbud; and
a substantially U-shaped body configured to be worn around a neck of a user, the U-shaped body comprising:
a left section configured to be disposed on the left side of the neck of the user, wherein the left section includes a first docking port configured to receive the first wireless earbud,
a right section configured to be disposed on the right side of the neck of the user, wherein the right section includes a second docking port configured to receive the second wireless earbud, and
a middle section coupling the left and right sections and configured to be disposed on the back of the neck of the user.

12. The wearable media device of claim 11, wherein the first docking port is disposed at an end of the left section and the second docking port is disposed at an end of the right section.

13. The wearable media device of claim 11, wherein the first docking port is disposed on an upper surface of the left section and the second docking port is disposed on an upper surface of the right section.

14. The wearable media device of claim 11, wherein the first and second wireless earbuds are detachable from the first and second docking ports, respectively.

15. The wearable media device of claim 14, wherein the first docking port comprises a socket configured to securely lock the first wireless earbud in place when the first wireless earbud is inserted into the socket.

16. The wearable media device of claim 15, wherein the first docking port comprises an electrical contact configured to charge the first wireless earbud when the first wireless earbud is inserted into the socket.

17. The wearable media device of claim 11, wherein the U-shaped body comprises a battery coupled to the first and second docking ports and configured to charge the first and second wireless earbuds.

18. The wearable media device of claim 11, wherein the U-shaped body comprises a user interface, the user interface including at least one of a control button, a haptic vibration device, a light emitting diode (LED), and a microphone.

19. The wearable media device of claim 11, wherein the U-shaped body comprises a semi-rigid, conformable material that enables the U-shaped body to be adapted to the size of the neck of the user and to the shape of the shoulders of the user.

20. The wearable media device of claim 19, wherein the U-shaped body comprises a closure mechanism configured to detachably connect an end of the left section and an end of the right section.
